(19) United States
(12) Patent Application Publication
(10) Pub. No.: US 2006/0130001 A1
(43) Pub. Date: Jun. 15, 2006

(54) Apparatus and method for call stack profiling for a software application

(75) Inventors: Daniel E. Beuch, Rochester, MN (US); Richard Allen Saltness, Rochester, MN (US); John Matthew Santosuosso, Rochester, MN (US)

Correspondence Address: MARTIN & ASSOCIATES, LLC, P.O. BOX 548, CARTHAGE, MO, 64836-0548, US

(73) Assignee: INTERNATIONAL BUSINESS MACHINES CORPORATION, ARMONK, NY (US)

(21) Appl. No.: 11/000,449

(22) Filed: Nov. 30, 2004

(51) Int. Cl. G06F 9/44

(52) U.S. Cl. 717/130

(57) ABSTRACT

A method and apparatus for monitoring the performance of a computer system with one or more active programs. A periodic sampling of the call stack is obtained. The sampled call stack is examined to infer the system performance similar to that obtained using prior art event based profiling. Embodiments also are directed to a combination approach to describing the system performance using a historical sampling to infer additional detail to fill in the gaps of the sampled data.

### BACKGROUND OF THE INVENTION

1. Technical Field

The present invention relates generally to monitoring performance of a data processing system, and in particular to an improved method and apparatus for structured profiling of the data processing system and applications executing within the data processing system.

2. Background Art

In analyzing and enhancing performance of a data processing system and the applications executing within the data processing system, it is helpful to know which software modules within a data processing system are using system resources. Effective management and enhancement of data processing systems requires knowing how and when various system resources are being used. Performance tools are used to monitor and examine a data processing system to determine resource consumption as various software applications are executing within the data processing system. For example, a performance tool may identify the most frequently executed modules and instructions in a data processing system, or may identify those modules which allocate the largest amount of memory or perform the most I/O requests. Hardware performance tools may be built into the system or added at a later point in time. Software performance tools also are useful in data processing systems, such as personal computer systems, which typically do not contain many, if any, built-in hardware performance tools.

One known software performance tool is a trace tool or profiler, which keeps track of particular sequences of instructions by logging certain events as they occur. For example, a profiler may log every entry into and every exit from a module, subroutine, method, function, or system component. Alternately, a profiler may log the requester and the amounts of memory allocated for each memory allocation request. Typically, a time stamped record is produced for each such event. Pairs of records similar to entry-exit records also are used to trace execution of arbitrary code segments, to record requesting and releasing locks, starting and completing I/O or data transmission, and for many other events of interest. The log information produced by a profiler is typically referred to as a “trace.”

Profiling based on the occurrence of defined events (or event based profiling) has drawbacks. For example, event based profiling is expensive in terms of performance (an event per entry, per exit), which can and often does perturb the resulting view of performance. Additionally, this technique is not always available because it requires the static or dynamic insertion of entry/exit events into the code. This insertion of events is sometimes not possible or is at least, difficult. For example, if source code is unavailable for the code in question, event based profiling may not be feasible.

Another known tool involves program sampling to identify events, such as program hot spots. This technique is based on the idea of interrupting the application or data processing system execution at regular intervals. At each interruption, the program counter of the currently executing thread is recorded. Typically, at post processing time, these tools capture values that are resolved against a load map and symbol table information for the data processing system and a profile of where the time is being spent is obtained from this analysis. Prior art sample based profiling provides a view of system performance with reduced cost and reduced dependence on hooking-capability, but lacks much of the detail needed for analysis of the program execution. These tools also provide such a large amount of data that the program can only run for a short period and the data output is difficult to analyze.

Therefore, it would be advantageous to have an improved method and apparatus for profiling data processing systems and the applications executing within the data processing systems. Without a way to analyze and improve system performance, the computer industry will continue to suffer from excessive costs due to poor computer system performance.

### DISCLOSURE OF INVENTION

An apparatus and method for monitoring the performance of a computer system with one or more active programs is provided. A periodic sampling of the call stack is obtained. The sampled call stack data is processed to infer the system performance similar to that obtained using prior art event based profiling without being as intrusive. Embodiments also are directed to a combination approach to describing the system performance using a historical sampling to infer additional detail to fill in the gaps of the sampled data.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is a block diagram of a system for call stack profiling in accordance with a preferred embodiment of the present invention;

FIG. 3 is method for call stack profiling in accordance with a preferred embodiment of the present invention;

FIG. 4 is a table of software module performance according to prior art event based profiling;

FIG. 5 depicts a timer based sampling of the call stack in accordance with a preferred embodiment of the present invention;

FIG. 6 depicts a table of software module performance derived from the timer based sampling of the call stack in FIG. 5 in accordance with a preferred embodiment of the present invention;

FIG. 7 is a diagram of a trace of all calls according to prior art event based profiling; and

FIG. 8 shows a time based sampling of the execution flow depicted in FIG. 7 in accordance with the prior art.

### BEST MODE FOR CARRYING OUT THE INVENTION

### 1.0 Overview

A system, method, and computer readable medium are provided for structured profiling of data processing systems and applications executing on the data processing system. Information is obtained from the call stack of an interrupted thread by a timer interrupt. The information on the stack is then processed to adjust the reported performance of the processes or application running on the system based on inferences drawn from the sampled call stack.

A “stack” is a region of reserved memory in which a program or programs store status data, such as procedure and function call addresses, passed parameters, and sometimes local variables. A call stack is an ordered list of stack frames that contain information about routines plus offsets within routines (i.e. modules, functions, methods, etc.) that have been entered or “called” during execution of a program. Since stack frames are interlinked (e.g., each stack frame points to the previous stack frame), it is possible to trace back up the sequence of stack frames and develop a “call stack.” A call stack represents all not-yet-completed function calls—in other words, it reflects the function invocation sequence at any point in time. For example, if routine A calls routine B, and then routine B calls routine C, while the processor is executing instructions in routine C, the call stack is ABC. When control returns from routine C back to routine B, the call stack is AB. Thus the call stack holds a record of the sequence of functions/method calls pending at the time of the interrupt or capture of the stack.

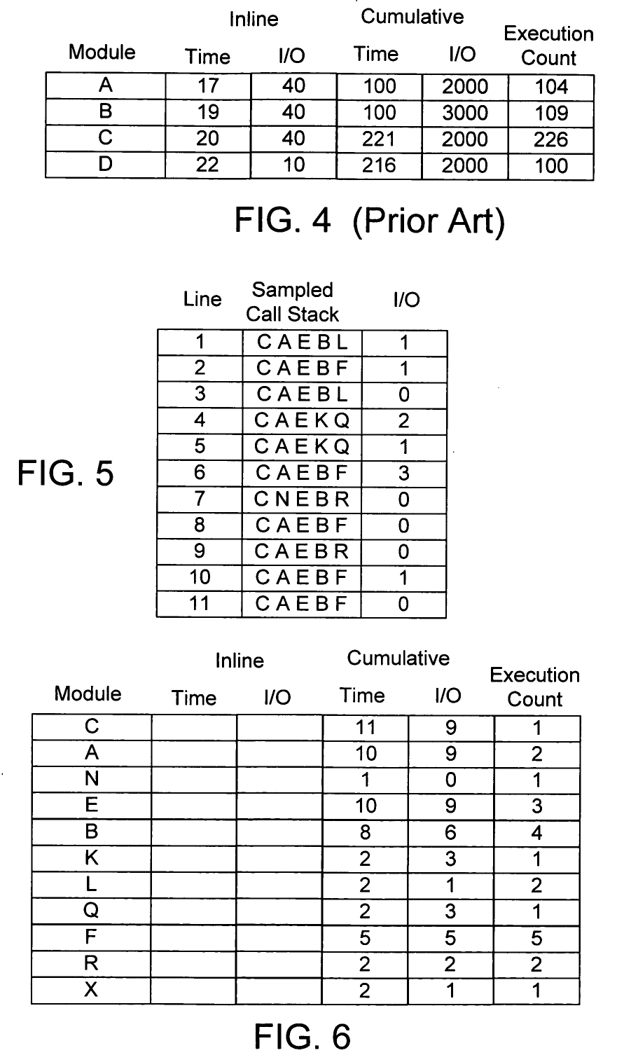

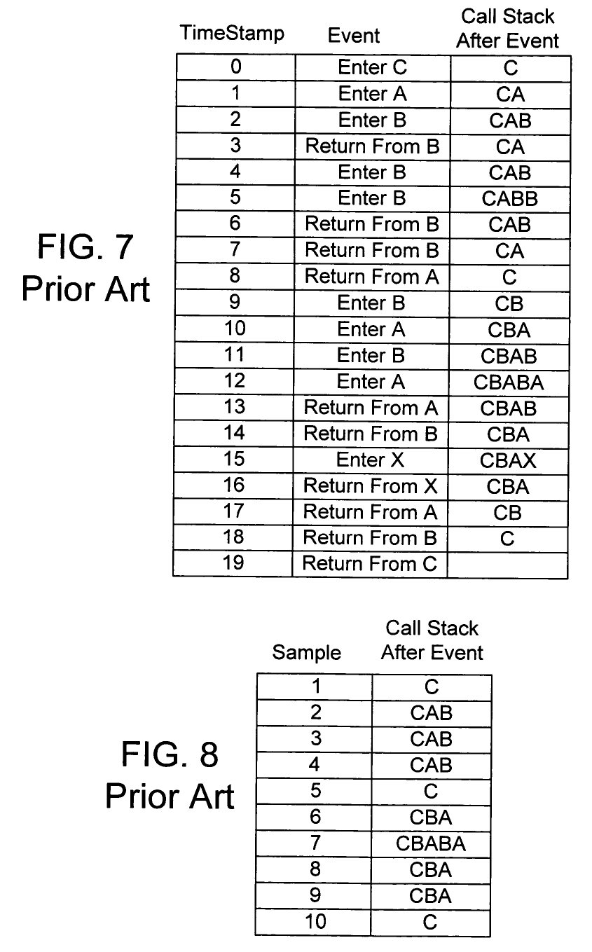

FIG. 7 shows a diagram of a program execution sequence along with the state of the call stack at each function entry/exit point according to the prior art. The illustration shows entries and exits occurring at regular time intervals—but this is only a simplification for the illustration. The sequence in FIG. 4 illustrates an example of event driven profiling. Unfortunately, this type of instrumentation can be expensive, introduce bias and in some cases be hard to apply. According to the described embodiments herein sampling the program's call stack reduces the performance bias (and other complications) that entry/exit hooks produce in an event driven profiler.

Consider FIG. 8, in which the same program in FIG. 7 is executed, but is being sampled on a regular basis (in the example, the interrupt occurs at a frequency that has a period equivalent to two timestamp values). Each sample includes a snapshot of the interrupted thread's call stack. Not all call stack combinations are seen with this technique (note that routine X does not show up at all in the set of call stack samples in FIG. 7). This is sometimes an acceptable limitation of sampling. The idea is that with an appropriate sampling rate (e.g., 30-100 times per second) the modules in which most of the time is spent will be identified from the call stack information. It would be desirable to be able to infer what these missed stack combinations are in FIG. 8 to more accurately analyze the system's performance as further described below with reference to preferred embodiments.

### 2.0 Description of the Preferred Embodiments

A system, method, and computer readable medium are provided for structured profiling of data processing systems and applications executing on the data processing system. It will be apparent to those skilled in the art that the claimed features can be incorporated into prior art computer systems. A suitable computer system is described below.

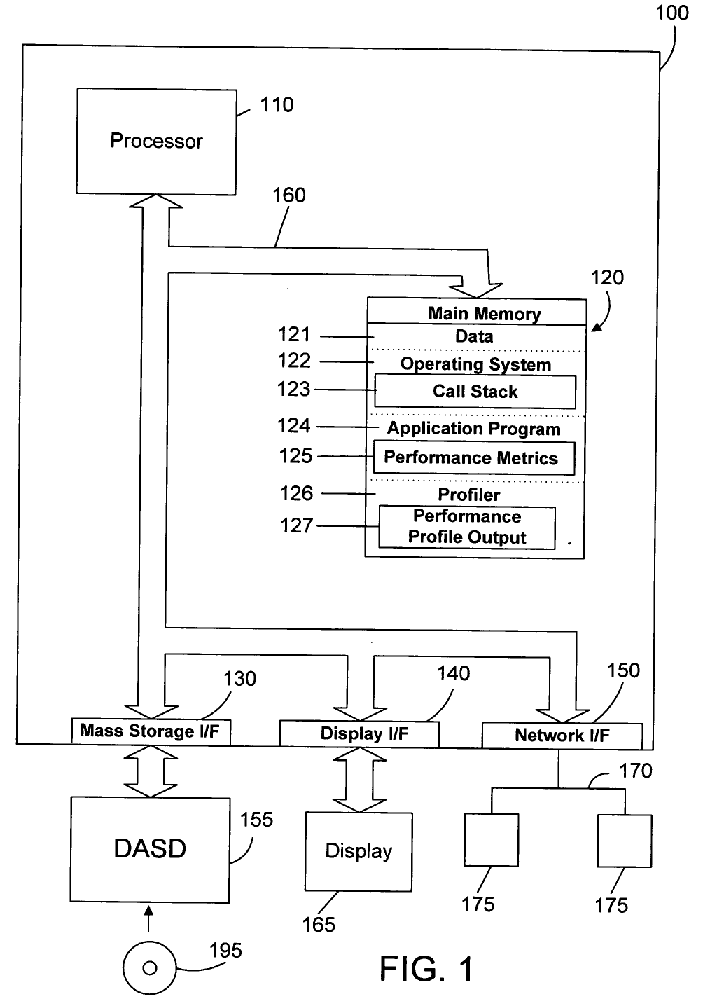

Referring to FIG. 1, a computer system 100 is shown in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD RW drive, which may store data to and read data from a CD RW 195.

Main memory 120 in accordance with the preferred embodiments contains data 121, an operating system 122, an application program 124 and a profiler 126. Data 121 represents any data that serves as input to or output from any program in computer system 100. Operating system 122 is a multitasking operating system known in the industry as OS/400; however, those skilled in the art will appreciate that the spirit and scope of the present invention is not limited to any one operating system. In the preferred embodiments, the operating system 122 includes a call stack 123 as described in the overview section. The application program 124 is a software program operating in the system that is to be monitored by the profiler 126. The application program and the profiler are described further below.

Each application program 124 in main memory 120 has attributes of operation that are hereinafter called performance metrics 125. These performance metrics 125 are things of interest to a system analyzer using the profiler to analyze system performance. The performance metrics are typically gathered by the operating system 122 or other processes operating on the computer 100. The performance metrics may be gathered by event driven processes or by computer hardware. Gathering the performance metrics is known to those skilled in the art. The performance metrics 125 may include I/O counts, CPU utilization, module invocation counts, page faults, cycles per instruction, data queue (dtaq) operations, file open operations, ifs (integrated file system) operations, socket operations, heap events, creation events, activation group operations lock events, java events, journal events, database operations and so forth. In the description of the embodiments in the following paragraphs, the performance metric used for illustration is the number of I/O counts. However, other performance metrics are hereby expressly included in the claimed embodiments.

The profiler 126 is a software tool for monitoring the performance of a computer system with one or more active programs. The profiler periodically samples the call stack d. The sampled call stack data is processed to infer the system performance and create the performance profile output 127. The profiler 126 and the performance profile output are described further below.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, application program 124 and the profiler 126 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol. The database described above may be distributed across the network, and may not reside in the same place as the application software accessing the database. In a preferred embodiment, the database primarily resides in a host computer and is accessed by remote computers on the network which are running an application with an internet type browser interface over the network to access the database.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD RW (e.g., 195 of FIG. 1), and transmission type media such as digital and analog communications links.

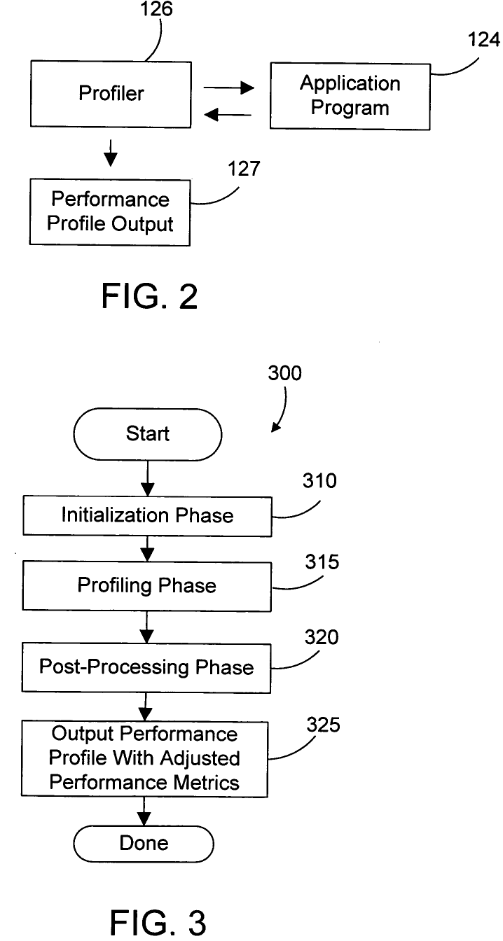

With reference now to FIG. 2, a block diagram depicts components used to profile processes in a data processing system. A profiler 126 is used to profile a process such as a process that executes as a part of application program 124 in FIG. 1. Profiler 126 may be used to record data samples of the call stack at regular time intervals. The time intervals can be those provided by a system interrupt, a hardware timer or a software timer. After post processing the profiler outputs a performance profile output 127.

With reference now to FIG. 3, a method 300 in accordance with the preferred embodiments depicts various phases in profiling the processes active in an operating system. An initialization phase (step 310) is used to set profiling parameters. The profiling parameters may include setting the sample frequency for sampling the stack, setting up the amount of data recorded, and setting up for recording historical data using event profiling as described further below. Next, during the profiling phase (step 315), data of a performance metric 125 is collected according to the profiling parameters selected in step 310. After data is collected for a predetermined period, or after collecting a set amount of data, or the execution is halted by a user; the profiling phase is complete (step 315). After the profiling phase, the post processing phase (step 320) processes the data to analyze the system performance according to the several methods described further below. In the post-processing phase (step 320), the data collected is sent to a file for post-processing. In one configuration, the file may be sent to a server, which determines the profile for the processes on the client machine. Of course, depending on available resources, the post-processing also may be performed on the client machine. At the completion of post processing, the data is formatted into the performance profile with the adjusted performance metrics is output (127 in FIG. 1) and sent to a display and/or file (step 325). In contrast to the prior art, the performance profile output 127 is adjusted by inferences drawn from the sampled call stack data as described below. In addition, the performance profile output 127 in embodiments herein is preferably in a format that is readily readable by a system analyst.

FIG. 4 represents a table of data collected using the software and techniques known in the prior art for event based profiling. As described above, event based profiling is very intrusive. The rows in FIG. 4 represent data collected for a specific software module running on the processor. The modules are given arbitrary designators A,B,C and D. The data collected includes the inline time, which is the amount of time the module is executing on the processor; and the inline I/O, which is the amount of I/O that occurs while the module is executing on the processor. The data collected also includes the cumulative time and I/O. The cumulative time and I/O is the total time and I/O that occurs while the module is on the stack. The data further includes the execution count, which is the number of times the module was executed for the time the profiler was monitoring the program's performance. The data collected according to this prior art technique is useful, but the tools used to collect this data are very intrusive to the overall system performance as described above. The embodiments described herein seek to produce the same or close to the same data using less intrusive sampled data from the call stack.

FIG. 5 shows collected data from a timer based sampling of the call stack in accordance with a preferred embodiment. The “Line” column gives a reference number for each row for ease of discussion. The “Sampled Call Stack” column gives the sequence of method calls on the stack at the instant of time when the sample is made. The I/O column gives the number of read/write operations that have occurred since the last sample. This column is the performance metric that is being used for the described example embodiments. Any other performance metric could be used. A non-exhaustive list of performance metrics is provided above. Since the number of I/O counts represents I/O counts since the last sample, the current method call on the stack may not be responsible for all the I/O calls. This will be described further below.

FIG. 6 shows a table of data similar to FIG. 4 but the data is extracted from the timer based sampling of the call stack shown in FIG. 5 in accordance with a preferred embodiment. The table in FIG. 6 has the same rows and columns as described for FIG. 4 above. Several embodiments herein are directed to extracting the data in the table of FIG. 5 and constructing the table of FIG. 6. The process of extracting the data and constructing the table of FIG. 6 may not always be 100 percent precise, but the table is constructed with an acceptable degree of accuracy with sampled data that is collected less intrusively and presented in a manner usable by the system analyst. Automated collection of a large amount of data (much more than shown in FIG. 6) and then using the data to infer the performance will increase the accuracy of the performance profile shown in FIG. 6. The inline time and inline I/O are shown blank in FIG. 6. Inline data can also be collected when sampling the call stack. The inline data can be collected for the module executing, the module at the bottom of the stack when the sample was taken, according to prior art techniques.

Again referring to FIG. 6, Module C has a cumulative time of 11. The unit of measure for the “Cumulative Time” column is the number of sample time intervals that the module is on the stack. The actual time would be the number of sample time intervals multiplied by the interval time. The value of 11 for cumulative time is determined by observing that Module C was on the stack during each of the 11 samples in FIG. 5. The I/O count for Module C is determined by adding the I/O count in each row that Module C is found on the stack. In this example the total I/O count for Module C is the total I/O count for samples 1 through 11, which is 9. The execution count for Module C is shown as one. This is inferred from the fact that in each sample, Module C is shown on the stack and no module precedes C to imply that the Module C on the stack is a separate invocation of Module C. Other rows in the table of FIG. 6 are populated in the same manner as described for Module C except as described to the contrary in subsequent paragraphs.

The samples with Module A shown in FIG. 6 illustrate a feature of a claimed embodiment. Module A has a cumulative time of 10 as shown in FIG. 6. The value of 10 for cumulative time is determined by observing that Module A was on the stack during 10 of the 11 samples in FIG. 5. The I/O count for Module A is determined by adding the I/O count in each row that Module A is found on the stack. In this example the total I/O count for Module A is 9. The execution count for Module A is 2. Module A's execution count is inferred from the fact that in each sample 1 through 6, Module A is shown on the stack. The execution count is determined by the profiler detecting a change in the call stack sequence between samples. In sample 7 in FIG. 5, Module A after Module C changes to Module N. Module A then returns in each sample 8 through 11. We infer with a high degree of accuracy that Module A on the stack in Samples 1 through 6 is a separate single invocation, and Module A on the stack in samples 8 through 11 is a second invocation of Module A.

Again referring to the samples with Module F shown in FIG. 6, another feature of a claimed embodiment is illustrated. The cumulative time for Module F is determined using the normal procedure as described above by observing that Module F is on the stack during 5 of the 11 samples in FIG. 5. Normally we would assume that module F in samples 10 and 11 represent a single invocation of F, as described above for Module A. However, in the case of Module F, the execution count for Module F is shown as 5 even though Module F is shown in consecutive samples in sample 10 and sample 11. The execution count is adjusted from 4 to 5 based on the probability that the Module F in sample 10 and sample 11 are different invocations of Module F. This adjustment is made as follows. Module F is shown in back to back samples in samples 10 and 11. If Module F is found to only show up in consecutive samples a very small percentage of the time (assuming more samples than shown in FIG. 5), and the performance metrics do not change over the set sample interval, then we can conclude that the invocation of Module F in sample 11 is a separate invocation of Module F in sample 10.

A variation of the previous example can also be used to adjust the invocation count of Module F. In the previous example we concluded that consecutive samples with Module F in the same last position were separate invocations. The opposite conclusion could also be drawn under different circumstances. The crossover of the sample boundary by Module F could be a single invocation in a situation where there is a slow down in the system performance. This would likely be detectable by observation of changes in one or more performance metrics or the CPU being busy. In this case we would not make the adjustment as described in the preceding paragraph.

The samples with Module F shown in FIG. 6 illustrate another feature of a claimed embodiment. In the previous illustrations, the I/O count for a module is determined by adding the I/O count in each row that a module is found on the stack. In this example the total I/O count for Module F is 5. However, we can observe that the I/O performance metric is nearly always a 1 or a 0 for the sample with Module F on the bottom of the stack. We can infer from this that the value of 3 for the I/O performance metric in sample 6 is most likely not attributable to Module F. This means that the module that accounted for at least 2 of the 3 counts of the performance metric has most likely come and gone off the stack between samples and is not represented in the sampled call stack. Using this information, the I/O count for Module F is adjusted from 5 to 3 (the total observed minus the value attributed to the missed module) to give a more accurate performance profile.

Other embodiments contemplate using historical data to supplement and enhance the sampled call stack profile. Historical data may be obtained through prior art techniques such as those described above using event based profiling. In a first embodiment, historical data is gathered using an intrusive prior art technique for a relatively short period of time. This data is analyzed to discover relationships of modules that always or nearly always occur. For example, if the historical technique shows that Module Q always invokes Module X, and that Module X has a I/O count of one, then the data in FIG. 6 could be modified to show that Module X has an execution count of 1 and an I/O count of 1. Therefore, the I/O count for Module Q would need to reflect the count assigned to Module X and thus would be set to 2 instead of 3 as shown in FIG. 6.

Another embodiment that uses historical data to supplement and enhance the sampled call stack profile is also shown in FIG. 6 with reference to Module Q. The cumulative time for a module can be determined from the historical profile data to fill in gaps in the sampled call stack data. In this example, the cumulative time for Module Q is determined from the historical profile data to always, or nearly always have a value of 1 time unit. Thus the cumulative time for Module Q is given a time of 1 as shown in FIG. 6.

In a further embodiment, the length of the sample interval, and the number of times a module appears in sequential entries on the call stack are used to statistically determine what percentage of time and CPU time is directly attributed to the modules on the stack. For example, in a large sampling of data, if a Module X appears to span two samples (appear in two sequential samples) 1% of the time, then the probability is that Module X is 1% greater than a single sample period. Similarly, if a Module X appears to span two samples 10% of the time, then the probability is that Module X is 10% greater than a single sample period. This determination can be used to adjust the CPU time attributed to Module X and reported by the profiler.

The present invention as described with reference to the preferred embodiments herein provides significant improvements over the prior art. In preferred embodiments the periodic sampling of the call stack is obtained and used to infer the system performance similar to that obtained using prior art event based profiling. The present invention provides a way to analyze and improve system performance using less intrusive sampled call stack data. This allows the system analysts to reduce the excessive costs caused by poor computer system performance.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An apparatus comprising:
at least one processor;
a memory coupled to the at least one processor having a selected application program executed by the at least one processor;
an operating system having a call stack for the selected application program with call stack information that shows the pending method calls from the selected application program; and
a performance profiler executed by the at least one processor that samples the call stack to generate sampled call stack data and adjusts a reported performance of the selected application program based on an inference drawn from the sampled call stack data.

2. The apparatus of claim 1 wherein the inference is drawn by post-processing the sampled call stack data.

3. The apparatus of claim 1 wherein the performance profiler determines the number of invocations of a particular module during a period of time by detecting changes in the sequence of modules on the call stack when the call stack is sampled.

4. The apparatus of claim 1 wherein the performance profiler adjusts the number of invocations reported for a selected module.

5. The apparatus of claim 1 wherein the performance profiler adjusts the number of invocations reported for a selected module and where the adjustment is based on consecutive samples of the call stack with the same first module on the stack and a different prior module.

6. The apparatus of claim 1 wherein the performance profiler adjusts the number of invocations reported for a selected module and where the adjustment is based on the probability that a module that lies in adjacent samples of the call stack is a different invocation of the module if in a high percentage of previous samples the module is on the stack for a smaller number of consecutive samples.

7. The apparatus of claim 1 wherein the performance profiler determines the value of a performance metric for a module by adding the performance metric for each sample period.

8. The apparatus of claim 7 wherein the performance profiler further determines the value of a performance metric for a module by adjusting the performance metric for modules that were most likely missed from being sampled.

9. The apparatus of claim 1 wherein the performance profiler adjusts the profile determined from the sampled call stack using historical data to supplement and enhance the sampled call stack data.

10. The apparatus of claim 9 wherein the performance profiler further determines the value of a performance metric for a module missed by the sampling of the call stack using the historical data.

11. The apparatus of claim 9 wherein the historical data is obtained by the performance profiler using event profiling.

12. An apparatus comprising:
at least one processor;
a memory coupled to the at least one processor having a selected application program executed by the at least one processor;
an operating system having a call stack with call stack information for the selected application program that shows the pending method calls from the selected application program; and
a performance profiler executed by the at least one processor that samples the call stack to generate call stack data using historical data obtained from event profiling to supplement and enhance the sampled call stack data.

13. The apparatus of claim 12 wherein the performance profiler adjusts a reported performance of the application program based on an inference drawn from the sampled call stack data.

14. A computer-implemented method for monitoring performance of a computer system with a performance profiler, the method comprising the steps of:
sampling the call stack to generate sampled call stack data; and
adjusting a reported performance of the application program based on an inference drawn from the sampled call stack data.

15. The method of claim 14 wherein the inference is drawn by post-processing the sampled call stack data.

16. The method of claim 14 wherein the performance profiler determines the number of invocations of a particular module during a period of time by detecting changes in the sequence of modules on the call stack when the call stack is sampled.

17. The method of claim 14 wherein the performance profiler adjusts the number of invocations reported for a selected module.

18. The method of claim 14 wherein the performance profiler adjusts the number of invocations reported for a selected module and where the adjustment is based on consecutive samples of the call stack with the same first module on the stack and a different prior module.

19. The method of claim 14 wherein the performance profiler adjusts the number of invocations reported for a selected module and where the adjustment is based on the probability that a module that lies in adjacent samples of the call stack is a different invocation of the module if in a high percentage of previous samples the module is on the stack for a smaller number of consecutive samples.

20. The method of claim 14 wherein the performance profiler determines the value of a performance metric for a module by adding the performance metric for each sample period.

21. The method of claim 20 wherein the performance profiler further determines the value of a performance metric for a module by adjusting the performance metric for modules that were most likely missed from being sampled.

22. The method of claim 14 wherein the performance profiler adjusts the profile determined from the sampled call stack using historical data to supplement and enhance the sampled call stack profile.

23. The method of claim 22 wherein the performance profiler further determines the value of a performance metric for a module missed by the sampling of the call stack using the historical data.

24. The method of claim 22 wherein the historical data is obtained by the performance profiler using event profiling.

25. A computer-implemented method for monitoring performance of a computer system with a performance profiler, the method comprising the steps of:
sampling the call stack to generate sampled call stack data; and
enhancing the sampled call stack data using historical data obtained from event profiling.

26. The method of claim 25 further comprising the step of adjusting a reported performance of the application program based on an inference drawn from the sampled call stack

27. A program product comprising:
(A) a profiler for monitoring performance of a computer system comprising:
a mechanism for sampling the call stack for a selected application program to generate sampled call stack data;
a mechanism for adjusting a reported performance of the selected application program based on an inference drawn from the sampled call stack; and
(B) computer-readable signal bearing media bearing the profiler.

28. The program product of claim 27 wherein the computer-readable signal bearing media comprises recordable media.

29. The program product of claim 27 wherein the computer-readable signal bearing media comprises transmission media.

30. The program product of claim 27 wherein the inference is drawn by post-processing the sampled call stack data.

31. The program product of claim 27 wherein the performance profiler determines the number of invocations of a particular module during a period of time by detecting changes in the sequence of modules on the call stack when the call stack is sampled.

32. The program product of claim 27 wherein the performance profiler adjusts the number of invocations reported for a selected module.

33. The program product of claim 27 wherein the performance profiler adjusts the number of invocations reported for a selected module and where the adjustment is based on consecutive samples of the call stack with the same first module on the stack and a different prior module.

34. The program product of claim 27 wherein the performance profiler adjusts the number of invocations reported for a selected module and where the adjustment is based on the probability that a module that lies in adjacent samples of the call stack is a different invocation of the module if in a high percentage of previous samples the module is on the stack for a smaller number of consecutive samples.

35. The program product of claim 27 wherein the performance profiler determines the value of a performance metric for a module by adding the performance metric for each sample period.

36. The program product of claim 35 wherein the performance profiler further determines the value of a performance metric for a module by adjusting the performance metric for modules that were most likely missed from being sampled.

37. The program product of claim 27 wherein the performance profiler adjusts the profile determined from the sampled call stack using historical data to supplement and enhance the sampled call stack profile.

38. The program product of claim 37 wherein the performance profiler further determines the value of a performance metric for a module missed by the sampling of the call stack using the historical data.

39. The program product of claim 37 wherein the historical data is obtained by the performance profiler using event profiling.

40. A program product comprising:
(A) a profiler for monitoring performance of a computer system comprising:
a mechanism for sampling the call stack for a selected application program to generate sampled call stack data;
a mechanism for enhancing the sampled call stack data using historical data obtained from event profiling; and
(B) computer-readable signal bearing media bearing the profiler.

41. The program product of claim 40 wherein the computer-readable signal bearing media comprises recordable media.

42. The program product of claim 40 wherein the computer-readable signal bearing media comprises transmission media.

43. The program product of claim 40 further comprising a mechanism for adjusting a reported performance of the application program based on an inference drawn from the sampled call stack data.
